(19) United States
(12) Patent Application Publication
(10) Pub. No.: US 2007/0192710 A1
(43) Pub. Date: Aug. 16, 2007

(54) Lean context driven user interface

(76) Inventors: Frank Platz, Waldorf (DE); Martin Semmier, Angelbachral (DE)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(21) Appl. No.: 11/355,825

(22) Filed: Feb. 15, 2006

(51) Int. Cl. G06F 9/00

(52) U.S. Cl. 715/764; 715/866; 715/765; 715/780

(57) ABSTRACT

A method for soliciting user interaction in a computer application includes presenting, on a first user interface screen, a most frequently accessed user interface portion for soliciting input from the user for a set of fields that are most frequently accessed. A semi-regularly access user interface portion is presented, on the first user interface screen, for allowing the user to provide input for a set of fields that are accessed semi-regularly. The user is allowed to switch to an expert user interface, on a second user interface screen, for allowing the user to provide input for any field.

### BACKGROUND

1. Technical Field

The present disclosure relates to a user interface and, more specifically, to a lean context driven user interface.

2. Description of the Related Art

Computer software intended to be used by an end user rather than a computer programmer generally encompasses elements designed to create an intuitive and user-friendly experience for the end user. These elements are commonly referred to as a User Interface (UI).

User interfaces facilitate the display of information to a user (output) and facilitate the entry of data by the user (input). In an attempt to make UIs more intuitive and user-friendly, modern UIs make use of graphical elements and multiple screens, menus and dialogs, all designed to provide the user with access to multiple options in an organized and intuitive way.

The more sophisticated the computer software the more user options may be available to the user and the more data the user may have to provide. Rather than display all available options on a single screen, user interfaces may display subsets of options and allow the user to navigate between these options. The options are generally organized by type to make it easier to locate a desired option.

Customer Relationship Management (CRM) software is a complex and multi-faceted tool for businesses to manage their relationships with internal and external customers by providing the framework necessary to guide employees towards successful implementation of business strategy and procedure.

Because CRM software organizes and implements a wide variety of data and procedures, user inputs and user outputs to and from CRM software tend to be large and complex. To help users more effectively navigate CRM software, CRM UIs tend to utilize a large number of specialized UI elements, each designed to present the user with a very limited and highly specialized sub-set of options available to the user.

While the display of sub-sets of options may often provide for a more user-friendly experience, there are times when it may be necessary for the user to have a greater set of options made available. For meeting this need, Expert UIs may be used to present the user with the full range of available options.

Expert UIs may provide a large number of available fields spanning over a large number of screens, each accessible via a tab. Fields may be organized under the various available tabs, grouped together according to their business context. For example, tabs may have labels such as customer information, price information, products, sales data etc. By selecting the desired tab, the user may be presented with the corresponding grouping of fields. An example of an Expert UI may be seen on FIG. 1. This example has been simplified for the purpose of providing a clear example, but it is to be understood that Expert UIs generally contain many more tabs and fields than the example shown in FIG. 1.

In traditional expert UIs, fields are organized under tabs according to business context so that a user may locate the desired fields. However, a user seeking to use the expert UI to execute a specific business process may find that fields organized according to business context offer little to no insight into what fields are required for what business process. It may additionally be difficult for the user to gain an appreciation for a particular business process when presented with fields organized according to business context. Moreover, in the process of filling in fields required for a particular business process, a user may have to switch between a large number of tabs. The user may therefore be forced to perform significant scrolling and navigating to ensure that all of the required information has been entered.

### SUMMARY

A method for soliciting user interaction in a computer application includes presenting, on a first user interface screen, a most frequently accessed user interface portion for soliciting input from the user for a set of fields that are most frequently accessed. A semi-regularly access user interface portion is presented, on the first user interface screen, for allowing the user to provide input for a set of fields that are accessed semi-regularly. The user is allowed to switch to an expert user interface, on a second user interface screen, for allowing the user to provide input for any field.

A user interface for soliciting user interaction in a computer application includes a most frequently accessed user interface portion, on a first user interface screen, for soliciting input from the user for a set of fields that are most frequently accessed. A semi-regularly access user interface portion, on the first user interface screen, allows the user to provide input for a set of fields that are accessed semi-regularly. A link, on the first user interface screen displays an expert user interface, on a second user interface screen, for allowing the user to provide input for any field.

A computer system includes a processor and a program storage device readable by the computer system, embodying a program of instructions executable by the processor to perform method steps for soliciting user interaction in a computer application. The method includes presenting, on a first user interface screen, a most frequently accessed user interface portion for soliciting input from the user for a set of fields that are most frequently accessed. A semi-regularly access user interface portion is presented, on the first user interface screen, for allowing the user to provide input for a set of fields that are accessed semi-regularly. The user is allowed to switch to an expert user interface, on a second user interface screen, for allowing the user to provide input for any field.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows a simplified screen view of an expert user interface;

FIG. 2 shows a simplified screen view of a lean context driven UI according to an embodiment of the present disclosure;

FIG. 3 is a chart illustrating an example of a CEL according to an embodiment of the present disclosure;

FIG. 4A is a diagram showing an example of multiple phases of a process according to an embodiment of the present disclosure;

FIG. 4B is a flow chart showing how a user may utilize a lean context driven UI according to an embodiment of the present disclosure; and

FIG. 5 shows an example of a computer system capable of implementing the method and apparatus according to embodiments of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present disclosure seek to provide a lean context driven UI that is intuitive and practical. The UI according to embodiments of the present disclosure may be split into two separate interfaces. The first interface may be a context driven lean UI. The second interface may be a full-blown expert UI. While the lean context driven UI may be the primary user interface, the expert UI may remain available for the limited circumstances when an advanced user wishes to access rarely used fields.

The context driven lean UI according to embodiments of the present disclosure may display most prominently those fields that the user uses most routinely from day-to-day. For example, the fields that cover, for example, 80% of the user's daily business may be presented prominently, for example, in a top portion of the screen. These most routinely accessed fields may be limited to those fields necessary for producing an error free document so that the user is not presented with a large number of fields that may not be necessary.

The most routinely accessed fields may be displayed, for example, according to the underlying business process currently being performed by the user. For example, a user wishing to generate a particular business document may be presented with a tab containing fields specifically necessary for generating the desired business document. Therefore, embodiments of the present disclosure may minimize the amount of scrolling and jumping back and forth between tabs.

The context driven lean UI may facilitate the user's performance of a multi-phased process. At each phase, the user may be presented with a simplified UI screen prominently displaying the fields necessary for performing that phase of the process (the most regular fields). The UI is context driven because the present UI screen is generated based on the mandatory information for the current process phase.

When one phase of the process has been completed, e.g. the user has filled all of the most routinely accessed and necessary fields; the UI screen for the subsequent phase may be displayed. The user may therefore be guided through the process by the simple and intuitive presentation of most routinely accessed and necessary fields with minimal navigation.

The list of fields that are most frequently used, and/or mandatory, may be predefined, based on the process steps. These fields may be configurable for each business process and may be tailored to user-specific requirements. The sequence of the fields

It is understood that there are times when even a novice user may desire to complete fields that are not among the most routinely accessed and necessary fields. As discussed above, the most routinely accessed and necessary fields may be, for example, those fields utilized 80% of the time.

The system need not dynamically adjust the necessary fields. Those fields utilized 80% of the time may be those fields that are predetermined to be mandatory and may additionally include additional fields with are known to be most important to the underlying business process.

Embodiments of the present disclosure may allow the user to easily access additional fields that are used semi-regularly. For example, the semi-regular fields may be those fields accessed 15% of the time. These fields may be displayed on-screen, for example, on the bottom half of the UI. Because there may be a large number of semi-regular fields compared to the number of most regular fields, the semi-regular fields may be organized into multiple tabs. The user may then be able to gain access to these semi-regular fields with some navigation.

It is understood that there are times when a user, for example an advanced user, may wish to gain access to the most-rarely used fields. For these cases, a full-blown expert UI may be made accessible, for example, by selecting an on-screen button.

It is a feature of some embodiments of the present disclosure that the user is permitted to, at any stage of the business process, save the information that the user has input into fields. For example, a user generating a business document may be able to save the document without regard to whether all of the information necessary to generate the business document has been entered or if entered information would result in a business document with errors (e.g. inconsistent or incorrect information has been entered). By allowing for saving at any point, user frustration may be reduced and reentry of information may be minimized.

Moreover, it is a feature of some embodiments of the present disclosure that the user is permitted to navigate, between the various phases of the business process. For example, a user generating a business document may be able to navigate without regard to whether all of the information necessary to generate the business document has been entered or if entered information would result in a business document with errors (e.g. inconsistent or incorrect information has been entered). By allowing for navigation at any point, user frustration may be reduced and reentry of information may be minimized.

According to other embodiments of the present disclosure, the user may be prohibited from navigating to a later phase before an earlier phase has been completed. This may be useful where there is dependency between the fields of an earlier phase and the fields of a later phase such that the necessary fields of the later phase cannot be determined until fields of the earlier phase have been entered.

Because the user is presented with a clear and simple user interface, reliance on on-screen guidance, for example, help balloons and instructions, may be greatly reduced. However, on-screen guidance may still be provided.

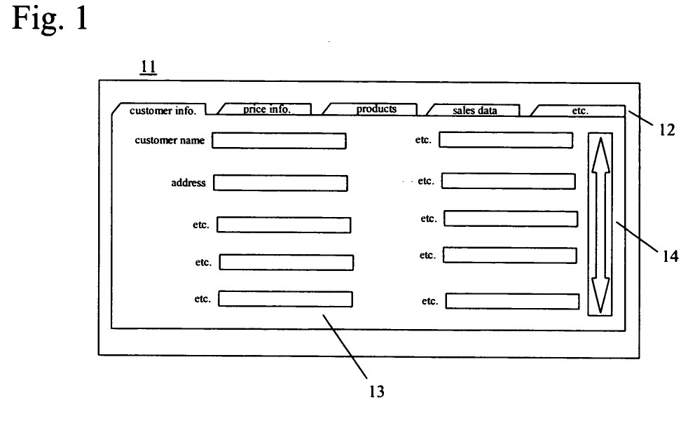

FIG. 1 is a simplified screen view of an expert user interface. The expert user interface 11 may include one or more tabs 12. Each of the tabs 12 may be selected to bring up one or more information fields 13 to be filled in. Navigational tools such as scroll bars 14 and the like may be used to access the various information fields 13 as there may be such a large number of information fields 13 for each tab 12 that all of the fields 13 cannot be displayed at the same time.

The fields 13 of the expert UI 11 may be organized into various tabs 12 according to the type of information that the fields relate to. For example, a tab called “customer information” may include customer name, customer address, etc. Conventional expert UIs do not organize fields into tabs according to process phases.

Embodiments of the present disclosure may make the expert UI available when needed but may not present the user with the expert UI unless specifically requested by the user.

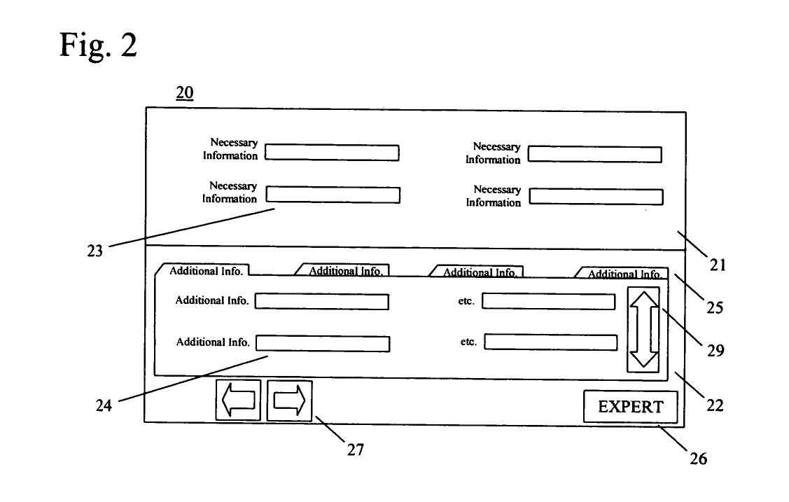

FIG. 2 is a simplified screen view of a lean context driven UI according to an embodiment of the present disclosure. The lean context driven UI 20 may be divided into an upper half 21 and a lower half 22. In the upper half 21, those most regularly used fields 23, for example those fields that must necessarily be completed in the current phase, for example those fields that are used 80% of the time, may be prominently displayed for the given phase. When all of the fields 23 of the given phase have been entered, the user may advance to the next phase and be presented with a similar UI, for example, by selecting navigation buttons 27.

Alternatively, the user may be automatically presented with the UI for the next phase when a phase is completed. The navigation buttons may be used to navigate between UIs for the various phases where such navigation is permitted.

In the lower half 22, those fields used semi-regularly 24, for example, those fields used 15% of the time, may be displayed. The semi-regular fields 24 may be organized according to one or more tabs 25. Navigation tools such as scroll bars 29 may be used to display additional fields.

It is understood that some fields will not be accessible either through the upper half 21 or the lower half 22. These most-rarely used fields, for example those fields used 5% of the time, may be accessed through an expert UI, for example, an expert UI similar to the one shown in FIG. 1. To provide for this option, an expert UI button 26 may be provided on the lean context driven UI 20.

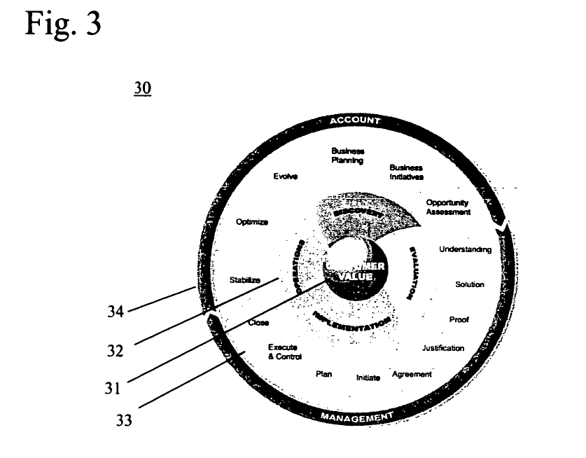

Lean context driven UIs according to embodiments of the present disclosure may be used to guide a user through the various phases of a process. A customer engagement lifecycle (CEL) is an overarching process for managing customer affairs. FIG. 3 is a chart illustrating an example of a CEL according to an embodiment of the present disclosure.

The CEL 30 shows concentric processes. At the center of the CEL is customer value 31 as maximizing customer value is at the core of the CEL process. At the next concentric ring 32, the CEL process is divided into four basic segments, namely “discovery,” “Evaluation,” “Implementation,” and “Operation.” Each segment represents a category of process phases. The next concentric ring 33 illustrates the process phases. Each process phase may correspond to a UI screen as described above. The process phases may include, “Business Planning,” “Business Initiatives,” “Opportunity Assessment,” “Understanding,” “Solution,” “Proof,” “Justification,” “Agreement,” “Initiate,” “Plan,” “Execute & Control,” “Close,” “Stabilize,” “Optimize,” and “Evolve.” At the next concentric ring 34, the process phases may be categorized as belonging either to the “Account” group or the “Management” group.

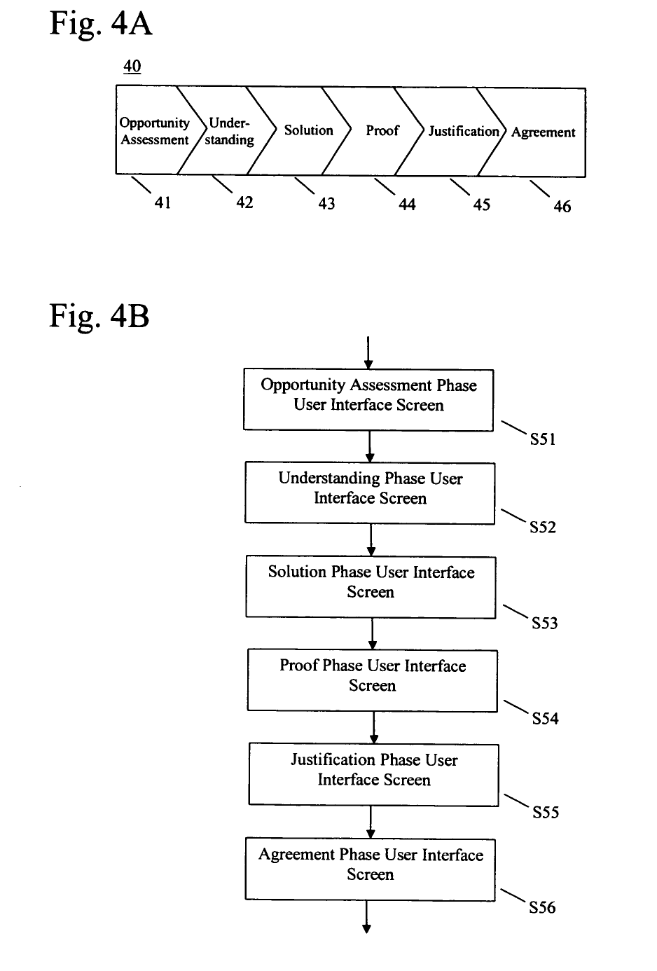

FIG. 4A is a diagram showing an example of multiple phases of a process according to an embodiment of the present disclosure. These process phases 40 may be a subset of a full CEL, for example, the CEL shown in FIG. 3. According to an embodiment of the present disclosure, there may be multiple process phases. For example, there may be an “Opportunity Assessment” phase 41, an “Understanding” phase 42, a “Solution” phase 43, a “Proof” phase 44, a “Justification” phase 45, and an “Agreement” phase 46.

Each process phase 31-36 of the process 30 may correspond to a lean context driven UI screen. FIG. 4B is a flow chart showing how a user may utilize a lean context driven UI according to an embodiment of the present disclosure. The user may be presented with an “Opportunity Assessment” screen S51 corresponding to the “Opportunity Assessment” phase 41. The user may use this screen to fill fields according to the user's needs as described above. When the “Opportunity Assessment” phase 41 is complete, for example, because all required fields have been filled and/or the user navigates to the next phase, the user may be presented with an “Understanding” screen S52 corresponding to the “Understanding” phase 42. When this phase is complete, the user may be presented with a “Solution” screen S53 corresponding to the “Solution” phase 43. When this phase is complete, the user may be presented with a “Proof” screen S54 corresponding to the “Proof” phase 44. When this phase is complete, the user may be presented with a “Justification” screen S55 corresponding to the “Justification” phase 45. When this phase is complete, the user may be presented with an “Agreement” screen S56 corresponding to the “Agreement” phase 46. After this phase is complete, the process may be completed and, for example, the desired business document may be generated.

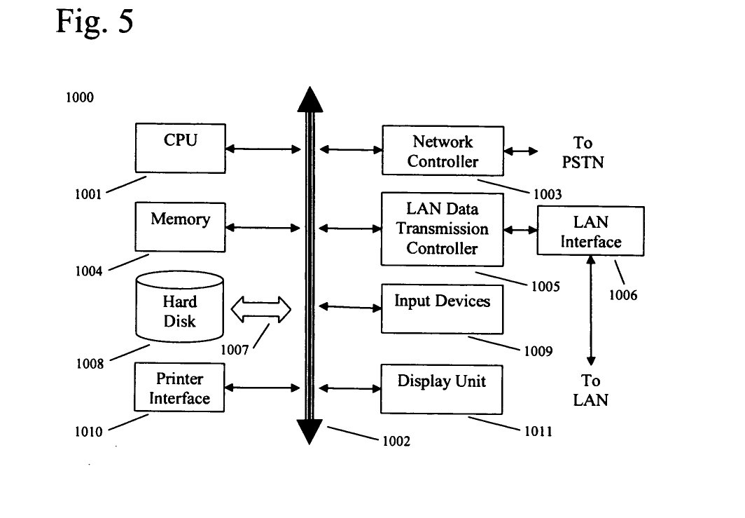

FIG. 5 shows an example of a computer system which may implement the method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. As shown, the system 1000 may be connected to a data storage device, for example, a hard disk, 1008 via a link 1007.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for soliciting user interaction in a computer application, comprising:
presenting, on a first user interface screen, a most frequently accessed user interface portion for soliciting input from the user for a set of fields that are most frequently accessed;
presenting, on the first user interface screen, a semi-regularly access user interface portion for allowing the user to provide input for a set of fields that are accessed semi-regularly; and
allowing the user to switch to an expert user interface, on a second user interface screen, for allowing the user to provide input for any field.

2. The method of claim 1, wherein the most frequently accessed user interface portion for soliciting input from the user for a set of fields that are most frequently accessed is, in a first phase, limited to soliciting input from the user for a set of fields that are most frequently accessed in the first phase and, in one or more subsequent phases, limited to soliciting input from the user for a set of fields that are most frequently accessed in the respective subsequent phase.

3. The method of claim 2, wherein the first phase is a first phase of a multi-phased business process and the one or more subsequent phases are one or more subsequent phases of the multi-phased business process.

4. The method of claim 1, wherein the computer application is a web portal in communication with a web server.

5. The method of claim 1, wherein the first user interface screen is split into two sections to display, in the first of the two sections, the most frequently accessed user interface portion, and in the second of the two sections, the semi-regularly access user interface portion.

6. The method of claim 1, wherein all fields of the most frequently accessed user interface portion are concurrently displayed.

7. The method of claim 1, wherein one or more the fields of the semi-regularly access user interface portion are accessible by navigation.

8. The method of claim 1, wherein the first user interface screen contains a link to the expert user interface on the second user interface screen.

9. The method of claim 1, wherein the set of fields that are most frequently accessed are mandatory fields.

10. The method of claim 1, wherein the set of fields that are most frequently accessed are the fields that are utilized 80% of the time.

11. The method of claim 1, wherein the set of fields that are accessed semi-regularly are the fields that are utilized 15% of the time.

12. A user interface for soliciting user interaction in a computer application, comprising:
a most frequently accessed user interface portion, on a first user interface screen, for soliciting input from the user for a set of fields that are most frequently accessed;
a semi-regularly access user interface portion, on the first user interface screen, for allowing the user to provide input for a set of fields that are accessed semi-regularly; and
a link, on the first user interface screen for displaying an expert user interface, on a second user interface screen, for allowing the user to provide input for any field.

13. The user interface of claim 12, wherein the most frequently accessed user interface portion for soliciting input from the user for a set of fields that are most frequently accessed is, in a first phase, limited to soliciting input from the user for a set of fields that are most frequently accessed in the first phase and, in one or more subsequent phases, limited to soliciting input from the user for a set of fields that are most frequently accessed in the respective subsequent phase.

14. The user interface of claim 13, wherein the first phase is a first phase of a multi-phased business process and the one or more subsequent phases are one or more subsequent phases of the multi-phased business process.

15. The user interface of claim 12, wherein the computer application is a web portal in communication with a web server.

16. The user interface of claim 12, wherein the first user interface screen is split into two sections to display, in the first of the two sections, the most frequently accessed user interface portion, and in the second of the two sections, the semi-regularly access user interface portion.

17. The user interface of claim 12, wherein all fields of the most frequently accessed user interface portion are concurrently displayed.

18. The user interface of claim 12, wherein one or more the fields of the semi-regularly access user interface portion are accessible by navigation.

19. The user interface of claim 12, wherein the first user interface screen contains a link to the expert user interface on the second user interface screen.

20. The user interface of claim 12, wherein the set of fields that are most frequently accessed are mandatory fields.

21. The user interface of claim 12, wherein the set of fields that are most frequently accessed are the fields that are utilized 80% of the time.

22. The user interface of claim 12, wherein the set of fields that are accessed semi-regularly are the fields that are utilized 15% of the time.

23. A computer system comprising:
a processor; and
a program storage device readable by the computer system, embodying a program of instructions executable by the processor to perform method steps for soliciting user interaction in a computer application, the method comprising:
presenting, on a first user interface screen, a most frequently accessed user interface portion for soliciting input from the user for a set of fields that are most frequently accessed;
presenting, on the first user interface screen, a semi-regularly access user interface portion for allowing the user to provide input for a set of fields that are accessed semi-regularly; and
allowing the user to switch to an expert user interface, on a second user interface screen, for allowing the user to provide input for any field.

24. The computer system of claim 23, wherein the most frequently accessed user interface portion for soliciting input from the user for a set of fields that are most frequently accessed is, in a first phase, limited to soliciting input from the user for a set of fields that are most frequently accessed in the first phase and, in one or more subsequent phases, limited to soliciting input from the user for a set of fields that are most frequently accessed in the respective subsequent phase.

25. The computer system of claim 24, wherein the first phase is a first phase of a multi-phased business process and the one or more subsequent phases are one or more subsequent phases of the multi-phased business process.

26. The computer system of claim 23, wherein the computer application is a web portal in communication with a web server.

27. The computer system of claim 23, wherein the first user interface screen is split into two sections to display, in the first of the two sections, the most frequently accessed user interface portion, and in the second of the two sections, the semi-regularly access user interface portion.

28. The computer system of claim 23, wherein all fields of the most frequently accessed user interface portion are concurrently displayed.

29. The computer system of claim 23, wherein one or more the fields of the semi-regularly access user interface portion are accessible by navigation.

30. The computer system of claim 23, wherein the first user interface screen contains a link to the expert user interface on the second user interface screen.

31. The computer system of claim 23, wherein the set of fields that are most frequently accessed are mandatory fields.

32. The computer system of claim 23, wherein the set of fields that are most frequently accessed are the fields that are utilized 80% of the time.

33. The computer system of claim 23, wherein the set of fields that are accessed semi-regularly are the fields that are utilized 15% of the time.
